(19) United States
(12) Patent Application Publication
(10) Pub. No.: US 2023/0198448 A1
(43) Pub. Date: Jun. 22, 2023

(54) DEVICE FOR REMOTELY DRIVING AND CONTROLLING ELECTROMECHANICAL MECHANISM BASED ON HAND DRIVER

(71) Applicant: Dongguan Geshengmei Industrial Co., Ltd, Dongguan (CN)

(72) Inventor: Taotao Lei, Dongguan (CN)

(21) Appl. No.: 17/553,863

(22) Filed: Dec. 17, 2021

(51) Int. Cl. H02P 29/00

(52) U.S. Cl. CPC H02P 29/00; H02K 7/1861

(57) ABSTRACT

The present utility model belongs to the technical field of electric control, in particular to a device for remotely driving and controlling an electromechanical mechanism based on a hand driver. In this solution, a hand driver, a motor unit and a power supply generated by the driver are used to remotely control the electromechanical mechanism to work in real time. Through each functional module, the motor in the remote motor unit can be controlled to rotate as long as the hand driver is cranked, thus driving the electromechanical mechanism or all devices driven by the motor; the crank of the driver can rotate the driver by hand or by foot; power is generated by the remote hand driver and supplied to the motor of the driven device; the rotation of the motor drives the electromechanical mechanism or the door to move; a movable part of the driven device is equipped with a gravity sensor connected with the driven motor, and when the electromechanical mechanism or the door clamps a creature, the gravity sensor will cut off the external power supply of the motor, stop the motor and stop the device from working, so as to protect the creature and allow it to have time to escape from the danger zone.

### TECHNICAL FIELD

The present utility model belongs to that technical field of electric control, in particular to a device for remotely driving and controlling an electromechanical mechanism based on a hand driver.

### BACKGROUND

At present, in the case of power failure, the special occasions far away from the power supply cannot get the external power supply to supply power to the electric push rod at the first time, which leads to the result that the electromechanical mechanism cannot work normally, and the electromechanical mechanism often suffers from the occurrence of incidents of creature clamping.

Therefore, in view of the technical defects that the electric mechanical mechanism cannot work normally because the external power supply cannot be obtained to supply power to the electric push rod at the first time in special occasions of being far away from a power supply, and the electric mechanical mechanism often suffers from the occurrence of incidents of creature clamping, it is urgent to design and develop a device for controlling the electric mechanical mechanism based on the remote drive of a hand driver.

### SUMMARY

The purpose of the present utility model is to provide a device for remotely driving and controlling an electromechanical mechanism based on a hand driver.

The purpose of the present utility model is realized as follows: the device specifically comprises: a hand driver for generating and providing power in real time; and a motor unit electrically connected with the hand driver through a power cord;

the motor unit electrically controls the electromechanical mechanism to work remotely in real time through the power generated by the hand driver.

Furthermore, the hand driver is provided with an indicator lamp circuit, a limit sensing circuit, a permanent magnet motor and one or more work indicator lamps.

Furthermore, the indicator lamp circuit is provided with a first current limiting resistor, and one end of the first current limiting resistor is respectively connected with one end of a second current limiting resistor and one end of a third current limiting resistor; the other end of the second current limiting resistor is connected with an anode of a first light emitting diode; the other end of the third current limiting resistor is connected with a cathode of a second light emitting diode;

the other end of the first current limiting resistor is respectively connected with a cathode of the first light emitting diode and an anode of the second light emitting diode.

Furthermore, one end of the first current limiting resistor, one end of the second current limiting resistor and one end of the third current limiting resistor are commonly connected with a cathode of a third rectifier diode, an anode of a fourth rectifier diode and a fourth pin of an adjustable potentiometer; an anode of that third rectify diode is respectively connected with a negative pow supply end of the adjustable potentiometer and an anode of a fifth rectifier diode; a cathode of the fourth rectify diode is respectively connected with a positive pow supply end of the adjustable potentiometer and a cathode of a sixth rectifier diode;

a cathode of the fifth rectifier diode and an anode of the sixth rectifier diode are commonly connected with one end of a hand generator motor and one end of a third switch; the other end of the first current limiting resistor, the cathode of the first light emitting diode, the anode of the second light emitting diode and one end of a bidirectional trigger diode are connected with a third pin of the adjustable potentiometer; the other end of the bidirectional trigger diode is respectively connected with a fifth pin of the adjustable potentiometer and an anode of a first rectifier diode.

Furthermore, the limit sensing circuit is provided with the first rectifier diode and a second rectifier diode; and

two ends of the first rectifier diode are connected with a first switch in parallel; two ends of the second rectifier diode are connected in parallel with a second switch.

Furthermore, the switch is a limit switch, a microswitch or an inductive switch.

Furthermore, the work indicator lamp is a light emitting diode or a LED screen display or a buzzer.

Furthermore, the driver is a pedal driver, and the pedal driver rotates the driver to work by way of a pedal.

Furthermore, the electromechanical mechanism is provided with a gravity sensor for sensing creatures;

when the gravity sensor senses that there is a creature in the electromechanical mechanism, a set motor control module controls the on or off of a power supply in real time.

Furthermore, the electromechanical mechanism is also provided with an anti-pinch sensor and at least two limit magnetic sensors;

the electromechanical mechanism is a door or a fan or a water pump or an air pump or a corresponding device driven by a motor.

The present utility model uses a hand driver for generating and providing power in real time; and a motor unit electrically connected with the hand driver through a power cord; the motor unit electrically controls the electromechanical mechanism to work remotely in real time through the power generated by the hand driver;

That is to say, through the solution of the present utility model, combined with each functional module in the solution, the motor in the remote motor unit can be controlled to rotate only by cranking the hand driver, thus driving the electromechanical mechanism or all devices driven by the motor, such as the electromechanical structure, doors, fans, water pumps, air pumps or all devices driven by the motor; the crank of the driver can rotate the driver by hand or by foot. The electric power is generated by the remote hand driver and supplied to the motor of the driven device. The rotation of the motor drives the electromechanical mechanism or the door to move. The movable part of the driven device is equipped with a gravity sensor connected with the driven motor. When the electromechanical mechanism or the door clamps a creature, the gravity sensor will cut off the external power supply of the motor, stop the motor and stop the device from working, so as to protect the creature and allow it to have time to escape from the danger zone.

### BRIEF DESCRIPTION OF DRAWINGS

In order to more clearly explain the technical solution in the embodiment of the present utility model, the following will briefly introduce the drawings needed in the description of the embodiment. Obviously, the drawings in the following description are only some embodiments of the present utility model. For ordinary technicians in the field, other drawings can be obtained according to these drawings without paying creative efforts.

FIG. 1 is a schematic diagram of the structure of a device for remotely driving and controlling an electromechanical mechanism based on a hand driver of the present utility model;

FIG. 2 is a schematic circuit diagram of a device for remotely driving and controlling an electromechanical mechanism based on a hand driver of the present utility model;

FIG. 3 is a schematic diagram of the second circuit diagram of a device for remotely driving and controlling an electromechanical mechanism based on a hand driver of the present utility model;

FIG. 4 is a schematic diagram of the third circuit diagram of a device for remotely driving and controlling an electromechanical mechanism based on a hand driver of the present utility model;

in which:

1- Hand generator motor; 2- driven motor; R1- First current limiting resistor; R2-Second current limiting resistor; R3- Third current limiting resistor; VD1- First light emitting diode; VD2- Second light emitting diode; D1- First rectifier diode; D2- Second rectifier diode; D3- Third rectifier diode; D4- Fourth rectifier diode; D5- Fifth rectifier diode; D6- Sixth rectifier diode; VR1- Adjustable potentiometer; K1- First switch; K2- Second switch; K3-Third switch; DIAC1- bidirectional trigger diode;

The purpose, function, features and advantages of the present utility model will be further explained with reference to the attached drawings.

### DESCRIPTION OF EMBODIMENTS

In order to better understand the purpose, technical solution and advantages of this utility model and make it clearer, the present utility model will be further explained below with reference to the attached drawings and specific embodiments, and those skilled in the art can easily understand other advantages and effects of this utility model from the contents disclosed in this specification.

The present utility model can also be implemented or applied by other different concrete examples, and various details in this specification can be modified and changed based on different viewpoints and applications without departing from the spirit of the present utility model.

It should be noted that if there are directional indications (such as up, down, left, right, front, back, ...) in this embodiment of the present utility model, the directional indication is only used to explain the relative positional relationship, movement situation, etc. among components in a certain posture (as shown in the attached figures), and if the specific posture changes, the directional indication will change accordingly.

In addition, if there are descriptions of “first” and “second” in the embodiment of the present utility model, the descriptions of “first” and “second” are only used for descriptive purposes, but cannot be understood as indicating or implying their relative importance or implicitly indicating the number of indicated technical features. Therefore, the features defined with “first” and “second” can explicitly or implicitly include at least one of the features. Secondly, the technical solutions of various embodiments can be combined with each other, but it must be based on the realization of ordinary technicians in this field. When the combination of technical solutions is contradictory or impossible to realize, it should be considered that the combination of such technical solutions does not exist and is not within the scope of protection required by the present utility model.

The present utility model is further explained with the attached drawings below.

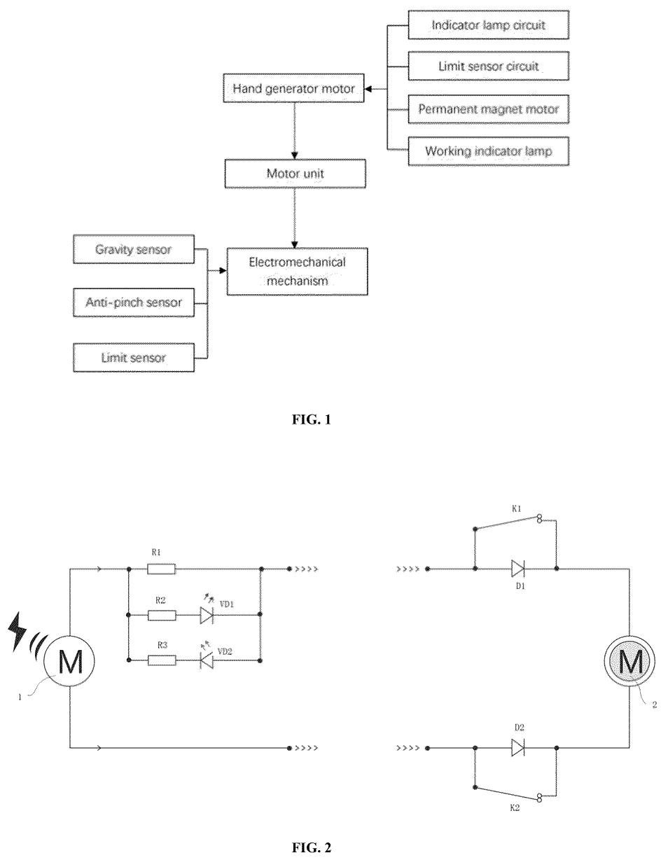

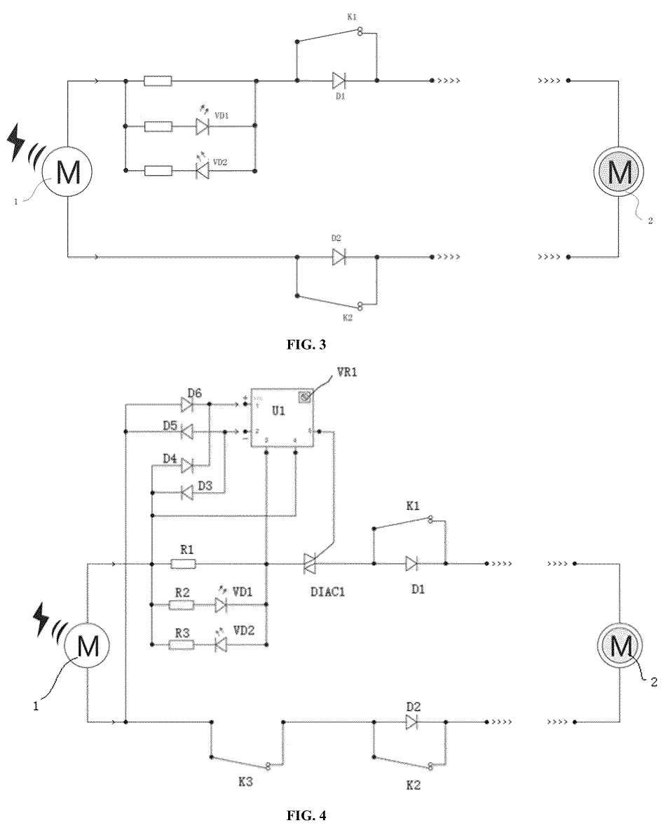

As shown in FIGS. 1-4, the present utility model provides a device for remotely driving and controlling electromechanical mechanism based on a hand driver, which specifically includes: a hand driver for generating and providing power in real time; and a motor unit electrically connected with the hand driver through a power cord;

the motor unit electrically controls the electromechanical mechanism to work remotely in real time through the power generated by the hand driver.

The hand driver is provided with an indicator lamp circuit, a limit sensing circuit, a permanent magnet motor and one or more work indicator lamps.

The indicator lamp circuit is provided with a first current limiting resistor R1, and one end of the first current limiting resistor R1 is respectively connected with one end of a second current limiting resistor R2 and one end of a third current limiting resistor R3; the other end of the second current limiting resistor R2 is connected with an anode of a first light emitting diode VD1; the other end of the third current limiting resistor R3 is connected with a cathode of a second light emitting diode VD2;
the other end of the first current limiting resistor R1 is respectively connected with a cathode of the first light emitting diode VD1 and an anode of the second light emitting diode VD2.
one end of the first current limiting resistor R1, one end of the second current limiting resistor R2 and one end of the third current limiting resistor R3 are commonly connected with a cathode of a third rectifier diode D3, an anode of a fourth rectifier diode D4 and a fourth pin of an adjustable potentiometer VR1; an anode of that third rectify diode D3 is respectively connected with a negative pow supply end of the adjustable potentiometer VR1 and an anode of a fifth rectifier diode D5; a cathode of the fourth rectify diode D4 is respectively connected with a positive pow supply end of the adjustable potentiometer VR1 and a cathode of a sixth rectifier diode D6; and
a cathode of the fifth rectifier diode D5 and an anode of the sixth rectifier diode D6 are commonly connected with one end of a hand generator motor 1 and one end of a third switch K3; the other end of the first current limiting resistor R1, the cathode of the first light emitting diode VD1, the anode of the second light emitting diode VD2 and one end of a bidirectional trigger diode DIAC1 are connected with a third pin of the adjustable potentiometer VR1; the other end of the bidirectional trigger diode DIAC1 is respectively connected with a fifth pin of the adjustable potentiometer VR1 and an anode of a first rectifier diode D1.

The limit sensing circuit is provided with the first rectifier diode D1 and a second rectifier diode D2; and

two ends of the first rectifier diode D1 are connected with a first switch Kl in parallel; two ends of the second rectifier diode D2 are connected in parallel with a second switch K2.

The switch is a limit switch, a microswitch or an inductive switch.

The work indicator lamp is a light emitting diode or a LED screen display or a buzzer.

The driver is a pedal driver, and the pedal driver rotates the driver to work by way of a pedal.

The electromechanical mechanism is provided with a gravity sensor for sensing creatures;

when the gravity sensor senses that there is a creature in the electromechanical mechanism, a set motor control module controls the on or off of a power supply in real time.

The electromechanical mechanism is also provided with an anti-pinch sensor and at least two limit magnetic sensors; and

the electromechanical mechanism is a door or a fan or a water pump or an air pump or a corresponding device driven by a motor.

Specifically, in that specific embodiment of the present utility model, a device for remotely driving and controlling the electromechanical mechanism base on a hand driver is provided; the hand driver in the device is internally provided with a permanent magnet motor and one or more work indicator lamps. When the hand driver is driven, the motor inside the driver rotates with it to generate electricity, which is connected to the driven motor unit through the power cord. After receiving the power from the power cord, the driven motor in the motor unit starts to rotate, and the electromechanical mechanism or door connected with the motor is driven by the rotation of the motor, so that the electromechanical mechanism or door moves.

In the driven electromechanical mechanism, the output shaft of the driven motor is electrically connected with an electromechanical mechanism or a door, at least two limit magnetic inductive switches are arranged on the electromechanical mechanism, and preferably, an anti-pinch sensor switch is also arranged in the electromechanical mechanism. When the motor rotates to drive the electromechanical mechanism or the door to close, if there is a creature or obstacle between the door and the anti-pinch sensor, the sensor will be powered off in real time when it is subjected to gravity, that is, the power supply between the motor and the power supply will be cut off in real time, so that the motor will stop working, thereby ensuring that creatures are not pinched when the electromechanical mechanism or door is closed; the switch can be a contact switch or a magnetic inductive switch or a corresponding inductive switch.

Preferably, the housing of the hand driver equipment is made of a metal or a hard material, and the hand driver generates electric power, is connected with the driven motor in the motor unit through the power connection line, and then electrically controls the electromechanical mechanism or door through the driven motor; An anti-pinch sensor is also arranged in the electrically controlled electromechanical mechanism or door. Further, when the hand driver rotates clockwise, the driven motor drives the electromechanical mechanism or door to open. When the hand driver rotates counterclockwise, the driven motor drives the electromechanical mechanism or door to close.

In the solution of the present utility model, the driver at least comprises a shell, a permanent magnet motor, a hand crank, an indicator lamp circuit and a limit sensing circuit. The indicator lamp circuit at least comprises a luminous indicator lamp; the light-emitting indicator lamp can be a light emitting diode, and an LED screen display can be used as a prompt, or a buzzer and other related sounding elements can be used as a prompt. The inductive switch circuit at least comprises a rectifier diode and a limit switch (a microswitch or inductive switch).

Preferably, the driven electromechanical mechanism at least includes a limit sensor (a limit switch) and an anti-pinch sensor.

Specific implementation process and principle are as below:

When the hand driver is cranked by hand, the permanent magnet motor inside the driver will run at a high speed, and the generated voltage and current will be supplied to the motor unit through the power connection line, so that the load motor in the motor unit will rotate. At this time, the indicator lamp in the hand driver will prompt (light up), indicating that the load is working; when the load is disconnected, the indicator lamp in the driver will go out, indicating that the load motor has finished working.

As shown in the figures, when the connected load is the driven motor M, when the hand driver rotates clockwise, the light emitting diode 1 (the first light emitting diode VD1) indicator lamps up. When the driven motor M meets the limit switch 2 (the second switch K2), the switch is started by contact or induction, the load is automatically turned off, and the light emitting diode 1 turns off and turns off. When the hand generator rotates counterclockwise, the indicator lamp of “light emitting diode 2” (the second light emitting diode VD2) lights up. When the driven motor M meets the “limit switch 1” (the first switch Kl), the switch is started by contact or induction, the load is automatically turned off, and “light emitting diode 2” turns off and turns off the light.

The specific suitable scene of this solution: the hand remote-driven electric push rod device suitable for doors, windows, fences, cover plates or electromechanical mechanisms driven by motors.

Installation principle of the hand driver: all accessories are fixed with screws, and there are several mounting screw holes in the hand driver, which can be fixed on the wall arm or the desktop platform with screws.

The present utility model uses a hand driver for generating and providing power in real time; and a motor unit electrically connected with the hand driver through a power cord; the motor unit electrically controls the electromechanical mechanism to work remotely in real time through the power generated by the hand driver;

That is to say, through the solution of the present utility model, combined with each functional module in the solution, the motor in the remote motor unit can be controlled to rotate only by cranking the hand driver, thus driving the electromechanical mechanism or all devices driven by the motor, such as the electromechanical structure, doors, fans, water pumps, air pumps or all devices driven by the motor; the crank of the driver can rotate the driver by hand or by foot. The electric power is generated by the remote hand driver and supplied to the motor of the driven device. The rotation of the motor drives the electromechanical mechanism or the door to move. The movable part of the driven device is equipped with a gravity sensor connected with the driven motor. When the electromechanical mechanism or the door clamps the creature, the gravity sensor will cut off the external power supply of the motor, stop the motor and stop the device from working, so as to protect the creature and allow it to have time to escape from the danger zone.

The above-mentioned examples only express several embodiments of the present utility model, and their descriptions are more specific and detailed, but they can’t be understood as limiting the patent scope of the present utility model. It should be pointed out that, for those skilled in the art, various changes and improvements can be made under the premise of not deviating from the concept of this utility model, and all the changes and improvements shall belong to the protection scope of this utility model. Therefore, the scope of protection of the present utility model patent shall be subject to the appended claims.

What is claimed is:

1. A device for remotely driving and controlling an electromechanical mechanism based on a hand driver, wherein the device specifically comprises: a hand driver for generating and providing power in real time; and a motor unit electrically connected with the hand driver through a power cord;
the motor unit electrically controls the electromechanical mechanism to work remotely in real time through the power generated by the hand driver.

2. The device for remotely driving and controlling an electromechanical mechanism based on a hand driver according to claim 1, wherein the hand driver is provided with an indicator lamp circuit, a limit sensing circuit, a permanent magnet motor and one or more work indicator lamps.

3. The device for remotely driving and controlling an electromechanical mechanism based on a hand driver according to claim 2, wherein the indicator lamp circuit is provided with a first current limiting resistor, and one end of the first current limiting resistor is respectively connected with one end of a second current limiting resistor and one end of a third current limiting resistor; the other end of the second current limiting resistor is connected with an anode of a first light emitting diode; the other end of the third current limiting resistor is connected with a cathode of a second light emitting diode;
the other end of the first current limiting resistor is respectively connected with a cathode of the first light emitting diode and an anode of the second light emitting diode.

4. The device for remotely driving and controlling an electromechanical mechanism based on a hand driver according to claim 3, wherein one end of the first current limiting resistor, one end of the second current limiting resistor and one end of the third current limiting resistor are commonly connected with a cathode of a third rectifier diode, an anode of a fourth rectifier diode and a fourth pin of an adjustable potentiometer; an anode of that third rectify diode is respectively connected with a negative pow supply end of the adjustable potentiometer and an anode of a fifth rectifier diode; a cathode of the fourth rectify diode is respectively connected with a positive pow supply end of the adjustable potentiometer and a cathode of a sixth rectifier diode; and
a cathode of the fifth rectifier diode and an anode of the sixth rectifier diode are commonly connected with one end of a hand generator motor and one end of a third switch; the other end of the first current limiting resistor, the cathode of the first light emitting diode, the anode of the second light emitting diode and one end of a bidirectional trigger diode are connected with a third pin of the adjustable potentiometer; the other end of the bidirectional trigger diode is respectively connected with a fifth pin of the adjustable potentiometer and an anode of a first rectifier diode.

5. The device for remotely driving and controlling an electromechanical mechanism based on a hand driver according to claim 2, wherein the limit sensing circuit is provided with the first rectifier diode and a second rectifier diode; and
two ends of the first rectifier diode are connected with a first switch in parallel; two ends of the second rectifier diode are connected in parallel with a second switch.

6. The device for remotely driving and controlling an electromechanical mechanism based on a hand driver according to claim 5, wherein the switch is a limit switch, a microswitch or an inductive switch.

7. The device for remotely driving and controlling an electromechanical mechanism based on a hand driver according to claim 2, wherein the work indicator lamp is a light emitting diode or a LED screen display or a buzzer.

8. The device for remotely driving and controlling an electromechanical mechanism based on a hand driver according to claim 1, wherein the driver is a pedal driver, and the pedal driver rotates the driver to work by way of a pedal.

9. The device for remotely driving and controlling an electromechanical mechanism based on a hand driver according to claim 1, wherein the electromechanical mechanism is provided with a gravity sensor for sensing creatures;
when the gravity sensor senses that there is a creature in the electromechanical mechanism, a set motor control module controls the on or off of a power supply in real time.

10. The device for remotely driving and controlling an electromechanical mechanism based on a hand driver according to claim 1, wherein the electromechanical mechanism is also provided with an anti-pinch sensor and at least two limit magnetic sensors;
the electromechanical mechanism is a door or a fan or a water pump or an air pump or a corresponding device driven by a motor.
